(19) United States
(12) Patent Application Publication
(10) Pub. No.: US 2011/0215990 A1
(43) Pub. Date: Sep. 8, 2011

(54) Apparatus for Obscuring Non-Displaying Areas of Display Panels

(76) Inventor: Klaus Christoph Liesenberg, Sao Paulo (BR)

(21) Appl. No.: 12/960,419

(22) Filed: Dec. 3, 2010

(30) Foreign Application Priority Data
Mar. 4, 2010 (BR) PI 100600-1

(51) Int. Cl. G09G 5/00

(52) U.S. Cl. 345/1.3

(57) ABSTRACT

An apparatus include an optical device having dimensions suitable for overlaying at least a portion of a non-displaying area between adjacent display panels of a tiled group of display panels. The optical device further has a bottom for contacting the adjacent display panels, sides and a top. A plurality of optical elements are substantially disposed within the optical device where the plurality of optical elements are operable for directing light, emitted by the adjacent display panels, to the top to obscure the portion of the non-displaying area with the directed light. The apparatus further includes means for processing information to be displayed on the display panels to produce a substantially uniform and seamless display of information on the tiled group of display panels.

### CROSS-REFERENCE TO RELATED APPLICATIONS

The present Utility patent application claims priority benefit under 35 U.S.C. 119(a) of the Brazilian patent application number PI 1000600-1 filed on Mar. 4, 2010 and entitled “DISPOSITIVO ÓTICO PARA OCULTAR BORDAS DE MONITORES ISOLADOS E DE ARRANJOS DE MONITORES”.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to tiled display devices. More particularly, the invention relates to an optical device for disguising the bezels of a single display device and for providing a seamless and uniform display image for a tiled display device.

### BACKGROUND OF THE INVENTION

The present invention refers to an optical device for hiding the bezels of a single monitor or Graphical User Interface (GUI) as well as the seams of tiled monitor arrays or tiled GUIs. Tiled GUIs have many different applications. Tiled GUIs enable the projection of an image over a large area. Tiled GUIs enable the projection of a significant amount of information and provide the capability to provide the information to a significantly large number of viewers. Such a device is very useful when applied on displays for signage, in control rooms, conference rooms as well as in general purpose displays

There are several solutions in the market for the implementation of large monitors based on the vertical and horizontal arrangement of smaller tile monitors in order to build one single visualization area extended over the whole array. The rear projected technologies (with DLP, LCD, LCOS etc. based rear-projectors) are the most adequate solutions, due to the fact that they can be built with very reduced seams (less then 1 mm) granting the perception of a perfect continuity of the rear-projected area and due the fact that they present small pixel (picture elements) sizes which are proper for short distance visualization. There are, also, giant monitors based on LEDs mounted in matrix arrangements, with predominant outdoor use and with relatively big pixel sizes, which demand a reasonable distancing for its perfect visualization. There are, also, solutions based on the arrangements of flat panels with plasma, LED or OLED technologies as well as with convention CRT tubes.

There are some inconvenient restrictions applicable to the several types described above which play against the broad use of these modular monitors. The major handicap of rear-projected Technologies is the continuous use of special lamps or of special illuminating systems, which increase significantly their ownership cost. The rear-projected systems also present reasonable difficulty for obtaining the perfect equalization of the total image along its usage time, due to intrinsic fluctuations and the ageing losses of the lamps, illuminating systems and their additional optical components, even in so called self adjusting systems, which finally require continuous maintenance. Additionally the rear-projected systems have relatively deep cabinets (40 to 120 cm) due to intrinsic optical reasons. The giant LED-based monitors present very high cost for configurations with reduced pixel size (2 to 3 mm), what goes against their use with short distance viewing (5 m or less), regardless of the fact that they possess a very good operational stability. These kind of LED-based monitors do not offer viable configurations with the pixel size of around 1 mm, which are proper for short distance viewing (2 m or less). The arrangements with flat panels present limited life time problems for Plasma and CRT based monitors. In general, the usability of flat panel based systems (Plasma, Oled, LCD etc.) is restricted due to the relatively big size of the composed monitor borders (typically 30 to 60 mm), which generate uncomfortable discontinuities in the total image. Recently special Plasma and LCD based monitors with reduced composed bezels (typically 4 to 8 mm) were launched. These devices relieve the described uncomforting visual feeling but do not eliminate it completely. Due to these restrictions, many display owners prefer using rear-projected devices, regardless of all described handicaps and disadvantages.

Tiled GUIs may present issues with respect to visual discontinuities and cursor trajectory as a result of interior bezels. Additionally, the interior bezels of tiled GUIs may detract from the image being displayed and deemed as a distraction by viewers. Manufacturers have produced GUIs with ultra thin bezels for reducing the width of the interfering bezels, but even tiled GUIs constructed of GUIs with ultra thin bezels experience performance degradation with respect to the displayed image.

In view of the foregoing, there is a need for improved techniques for providing a tiled GUI with a seamless display of information.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a conventional GUI;

FIG. 2 illustrates an example of a conventional tiled GUI;

FIG. 3 illustrates an exemplary optical device for providing seamless integration of tiled GUIs, in accordance with an embodiment of the present invention;

FIG. 4A illustrates a cross sectional view of FIG. 3 for an exemplary optical device for providing seamless integration of tiled GUIs, in accordance with an embodiment of the present invention;

FIG. 4B illustrates a cross sectional view of FIG. 3 for an exemplary optical device for providing seamless integration of tiled GUIs where exemplary optical device may extend over active area of a GUI, in accordance with an embodiment of the present invention;

FIG. 4C illustrates transmission of optical radiation via GUIs and reception of optical radiation by optical device as depicted in FIG. 4A, in accordance with an embodiment of the present invention;

FIG. 4D illustrates transmission of optical radiation via GUIs and reception of optical radiation by optical device as depicted in FIG. 4B, in accordance with an embodiment of the present invention;

FIG. 4E illustrates reception of optical radiation generated from GUIs, as depicted in FIG. 4C, by optical device and transmission of redirected optical radiation by optical device, in accordance with an embodiment of the present invention;

FIG. 4F illustrates reception of optical radiation generated from GUIs, as depicted in FIG. 4D, by optical device and transmission of redirected optical radiation by optical device, in accordance with an embodiment of the present invention;

FIG. 4G illustrates a magnified view of FIG. 4E with reference to optical radiation received by optical device and to optical radiation transmitted by optical device, in accordance with an embodiment of the present invention;

FIG. 4H illustrates a magnified view of FIG. 4F with emphasis on optical radiation received by optical device and on optical radiation transmitted by optical device, in accordance with an embodiment of the present invention;

FIG. 4I illustrates a view of FIG. 4G with optical device implemented via a multiplicity of optical lenses, in accordance with an embodiment of the present invention;

FIG. 4J illustrates a view of FIG. 4H with optical device implemented via a multiplicity of optical lenses, in accordance with an embodiment of the present invention;

FIG. 4K illustrates a view of FIG. 4G with optical device implemented via a multiplicity of optical fibers, in accordance with an embodiment of the present invention;

FIG. 4L illustrates a view of FIG. 4H with optical device implemented via a multiplicity of optical fibers, in accordance with an embodiment of the present invention;

FIG. 4M illustrates a view of FIG. 4G with optical device implemented via a multiplicity of optical prisms, in accordance with an embodiment of the present invention;

FIG. 4N illustrates a view of FIG. 4H with optical device implemented via a multiplicity of optical prisms, in accordance with an embodiment of the present invention;

FIG. 4P illustrates a view of FIG. 4G with optical device implemented via a multiplicity of optical lenses, fibers and prisms, in accordance with an embodiment of the present invention;

FIG. 4Q illustrates a view of FIG. 4H with optical device implemented via a multiplicity of optical lenses, fibers and prisms, in accordance with an embodiment of the present invention;

FIG. 5 illustrates non-uniform image intensity, color and/or resolution for generating a uniform image via a tiled GUI, in accordance with an embodiment of the present invention;

FIG. 6 presents a flow chart illustrating an exemplary method 600 for modification of a display of information via processing as described with reference to FIG. 5 in order to compensate for losses attributed to optical devices for generating a uniform display of information; and

FIG. 7 illustrates a typical computer system that, when appropriately configured or designed, may serve as a computer system for which the present invention may be embodied.

Unless otherwise indicated illustrations in the figures are not necessarily drawn to scale.

### SUMMARY OF THE INVENTION

To achieve the forgoing and other objects and in accordance with the purpose of the invention, an apparatus for obscuring non-displaying areas of display panels is presented.

In one embodiment an apparatus includes means for overlaying at least a portion of a non-displaying area between adjacent display panels of a tiled group of display panels, and means substantially disposed within the overlaying means for directing light emitted by the adjacent display panels to obscure the portion of the non-displaying area with the directed light. Another embodiment further includes means for processing information to be displayed on the display panels to produce a substantially uniform and seamless display of information on the tiled group of display panels.

In another embodiment an apparatus includes an optical device having dimensions suitable for overlaying at least a portion of a non-displaying area between adjacent display panels of a tiled group of display panels. The optical device further having a bottom for contacting the adjacent display panels, sides and a top. A plurality of optical elements are substantially disposed within the optical device where the plurality of optical elements are operable for directing light, emitted by the adjacent display panels, to the top to obscure the portion of the non-displaying area with the directed light. In another embodiment the plurality of optical elements receives light from the sides. In yet another embodiment the bottom overlaps displaying areas of the adjacent display panels and the plurality of optical elements receives a portion of light from the bottom. In still another embodiment the non-displaying area includes bezels of the adjacent panels and the bottom contacts bezels of the adjacent panels. In another embodiment the dimensions of the optical device are suitable for overlaying all non-displaying areas between adjacent display panels. In yet another embodiment the optical device intersects its self. In still another embodiment the plurality of optical elements comprises elements chosen from a group comprising optical lenses, optical fibers, optical prisms, nano-optics, optical coatings, micro lenses, micro prisms, flat lenses and mirrors. In another embodiment the optical device comprises a generally rectangular shape. Yet another embodiment further includes means for processing information to be displayed on the display panels to produce a substantially uniform and seamless display of information on the tiled group of display panels. In still another embodiment brightness of display areas of the display panels are manipulated. In another embodiment resolutions of display areas of the display panels are modified.

In another embodiment a method for processing information to be displayed on display panels to produce a substantially uniform and seamless display of information on a tiled group of display panels utilizing an apparatus for obscuring a non-displaying area between adjacent display panels, includes steps of receiving a portion of the information intended for display on the tiled group of display panels. Determining if the portion is to be displayed in a predetermined area that has been designated for a modification. If the portion is in the predetermined area, determining an algorithm to produce the modification and applying the algorithm to the portion. Displaying the portion. In another embodiment the predetermined area is adjacent to a bezel of the tiled group of display panels. In yet another embodiment the modification is to compensate for the apparatus. In still another embodiment the modification varies display intensity. In another embodiment the modification varies display resolution.

Other features, advantages, and objects of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

A first embodiment of the present invention will be described which provides means and methods for generating a seamless display of information via a tiled GUI. Optical devices may be overlaid on a tiled GUI for reception, redirection and transmission of optical radiation generated by the display portion of a GUI or the display portions of a multiplicity of GUIs. Optical devices may be overlaid over bezel portions of GUIs or over bezel portions and display portions of GUIs. For optical devices overlaid over bezel portions of GUIs, the sides of the optical devices may operate to receive the optical radiation emitted by the display portions of the GUIs. For optical devices overlaid over bezel portions of GUIs and display portions of GUIs, the sides and bottom of optical devices may operate to receive the optical radiation emitted by the display portions of the GUIs. Optical devices may operate to receive optical radiation emitted by the display portion of GUIs for redirection and transmission of the received optical radiation external to the optical devices for viewing by a user or users. Optical radiation received, redirected and transmitted by optical devices may be emitted via the top or side portions of the optical devices. Optical devices may contain elements for receiving, redirecting and transmitting optical radiation emitted by the display portions of GUIs. Non-limiting examples of the elements for performing the reception, redirection and transmission of optical radiation include optical lenses, optical fibers, optical prisms, nano-optics, optical coatings, micro lenses, micro prisms, flat lenses and mirrors. Furthermore, the previously mentioned examples of elements for performing the reception, redirection and transmission of optical radiation may include a multiplicity of the various elements and also a variety of the various elements.

In other embodiments of the present invention, a method and means will be described for generating a uniform and seamless display of information for a tiled GUI via the application of image processing and other image enhancement techniques. Processing of information for providing a uniform and seamless display of information may be performed prior to reception of the information by tiled GUI. Furthermore, processing of information for providing a uniform and seamless display of information may be performed by elements located within or associated with tiled GUI. Furthermore, backlighting for the display areas of GUIs may be manipulated for providing a seamless and uniform display of information. Furthermore, brightness for the display areas of GUIs may be manipulated for providing a seamless and uniform display of information.

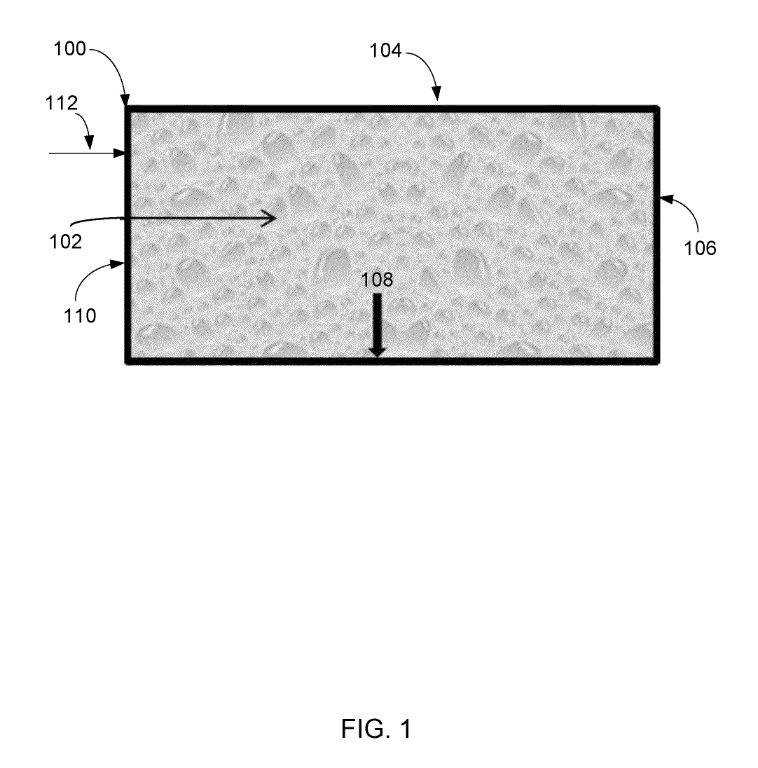

FIG. 1 illustrates a conventional GUI.

A GUI 100 includes a display portion 102, a bezel portion 104, a bezel portion 106, a bezel portion 108 and a bezel portion 110.

GUI 100 may operate to receive information via a communication channel 112 for controlling GUI 100 and displaying information via GUI 100. Information may be received via communication channel 112 for configuring and controlling the operation of GUI 100. Non-limiting examples of elements configured and controlled via communication channel 112 include intensity, color, color hue and resolution. Display portion 102 may operate to display information for viewing by user or users (not shown). Bezel portions 104, 106, 108 and 110 may operate to support and protect display portion 102.

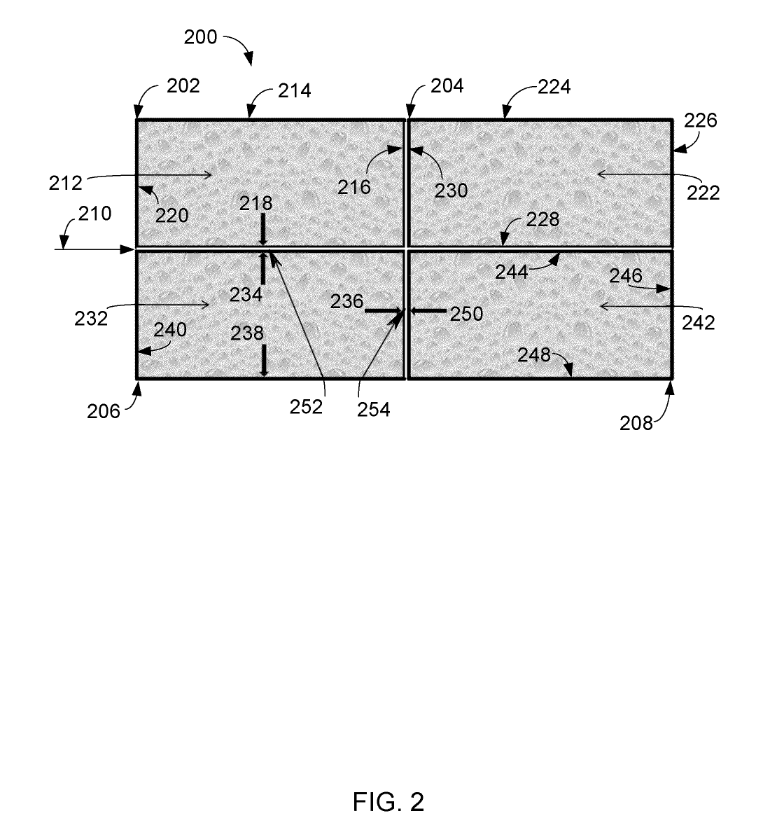

FIG. 2 illustrates an example of a conventional tiled GUI.

A tiled GUI 200 includes a GUI 202, a GUI 204, a GUI 206 and a GUI 208.

Tiled GUI 200 may operate to receive information via a communication channel 210 for controlling GUIs 202, 204, 206 and 208 and displaying information via GUIs 202, 204, 206 and 208.

Information may be received via communication channel 210 for configuring and controlling the operation of GUIs 202, 204, 206 and 208. Non-limiting examples of elements configured and controlled via communication channel 210 include intensity, color, color hue and resolution.

GUI 202 includes a display portion 212, a bezel portion 214, a bezel portion 216, a bezel portion 218 and a bezel portion 220. GUI 204 includes a display portion 222, a bezel portion 224, a bezel portion 226, a bezel portion 228 and a bezel portion 230. GUI 206 includes a display portion 232, a bezel portion 234, a bezel portion 236, a bezel portion 238 and a bezel portion 240. GUI 208 includes a display portion 242, a bezel portion 244, a bezel portion 246, a bezel portion 248 and a bezel portion 250.

Tiled GUI 200 may operate to display information for viewing by user or users (not shown). Bezel portions 214, 216, 218 and 220 may operate to support and protect display portion 212. Bezel portions 224, 226, 228 and 230 may operate to support and protect display portion 222. Bezel portions 234, 236, 238 and 240 may operate to support and protect display portion 232. Bezel portions 244, 246, 248 and 250 may operate to support and protect display portion 242.

A space 252 may be present and separate GUI 202 from GUI 206 and GUI 204 from GUI 208. A space 254 may be present and separate GUI 202 from GUI 204 and GUI 206 from GUI 208.

Space 252 and bezel portions 218 and 234 may operate to provide a discontinuity for image displayed via tiled GUI 200 with respect to display portions 212 and 232. Space 252 and bezel portions 228 and 244 may operate to provide a discontinuity for image displayed via tiled GUI 200 with respect to display portions 222 and 242. Space 254 and bezel portions 216 and 230 may operate to provide a discontinuity for image displayed via tiled GUI 200 with respect to display portions 212 and 222. Space 254 and bezel portions 236 and 250 may operate to provide a discontinuity for image displayed via tiled GUI 200 with respect to display portions 232 and 242.

FIG. 2 illustrates how spaces between GUIs and bezel portions of GUIs may operate to distort an image as displayed via tiled GUI 200.

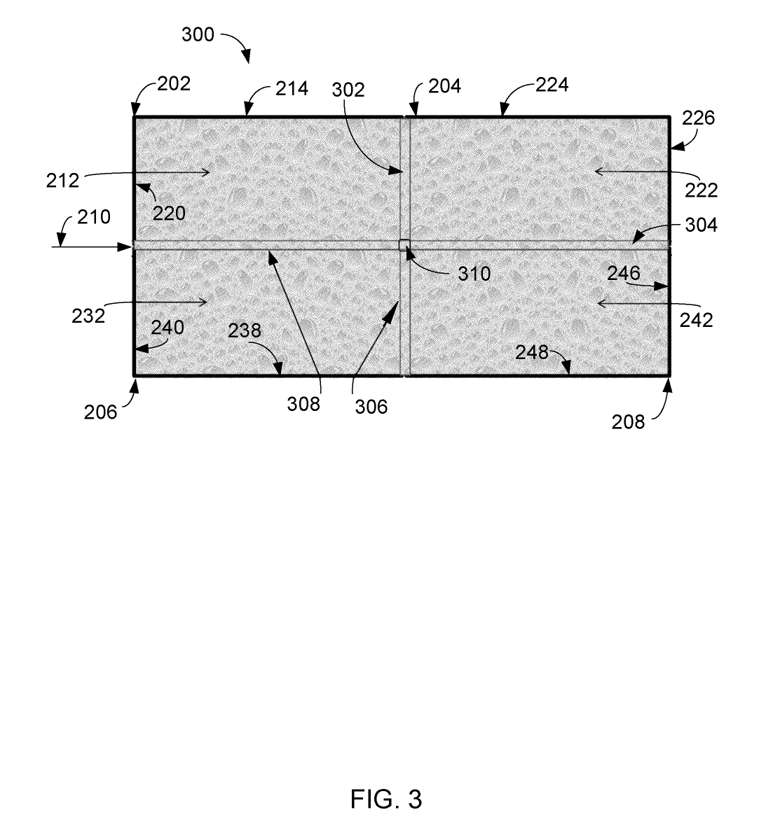

FIG. 3 illustrates an exemplary optical device for providing seamless integration of tiled GUIs, in accordance with an embodiment of the present invention.

Elements of FIG. 2 in common with FIG. 3, previously described with reference to FIG. 2, will not be described with respect to FIG. 3.

A tiled GUI 300 includes GUI 202, GUI 204, GUI 206, GUI 208, an optical device 302, an optical device 304, an optical device 306, an optical device 308 and an optical device 310.

Optical device 302 may be configured to cover a portion of space 254 (FIG. 2), bezel portion 216 (FIG. 2) and bezel portion 230 (FIG. 2). Furthermore, optical device 302 may operate to receive optical radiation generated by display portion 212 and display portion 222 and perform redirection and transmission of received optical radiation for viewing by a user or users.

Optical device 304 may be configured to cover a portion of space 252 (FIG. 2), bezel portion 228 (FIG. 2) and bezel portion 244 (FIG. 2). Furthermore, optical device 304 may operate to receive optical radiation generated by display portion 222 and display portion 242 and perform redirection and transmission of received optical radiation for viewing by a user or users.

Optical device 306 may be configured to cover a portion of space 254 (FIG. 2), bezel portion 236 (FIG. 2) and bezel portion 250 (FIG. 2). Furthermore, optical device 306 may operate to receive optical radiation generated by display portion 232 and display portion 242 and perform redirection and transmission of received optical radiation for viewing by a user or users.

Optical device 308 may be configured to cover a portion of space 252 (FIG. 2), bezel portion 218 (FIG. 2) and bezel portion 234 (FIG. 2). Furthermore, optical device 308 may operate to receive optical radiation generated by display portion 212 and display portion 232 and perform redirection and transmission of received optical radiation for viewing by a user or users.

Optical device 310 may be configured to cover portions of space 252 (FIG. 2) and space 254 (FIG. 2), and portions of bezel portion 216 (FIG. 2), bezel portion 230 (FIG. 2), bezel portion 228 (FIG. 2), bezel portion 244 (FIG. 2), bezel portion 250 (FIG. 2), bezel portion 236 (FIG. 2), bezel portion 234 (FIG. 2), bezel portion 218 (FIG. 2). Furthermore, optical device 310 may operate to receive optical radiation generated by display portion 212, display portion 222, display portion 232 and display portion 232 and perform redirection and transmission of received optical radiation for viewing by a user or users.

FIG. 3 illustrates configuration of multiple GUIs for application of optical device, however, optical device may be implemented for a single GUI, GUI 202 for example with optical devices covering bezel portions 214, 216 (FIG. 2), 218 (FIG. 2) and 220.

FIG. 3 illustrates implementing optical devices for covering bezels and spaces located between GUIs for receiving optical radiation from GUIs and performing redirection and transmission of optical radiation for viewing by a user or users. Furthermore, implementation of optical devices may operate to provide a display of information via a tiled GUI without the appearance of seams located between GUIs.

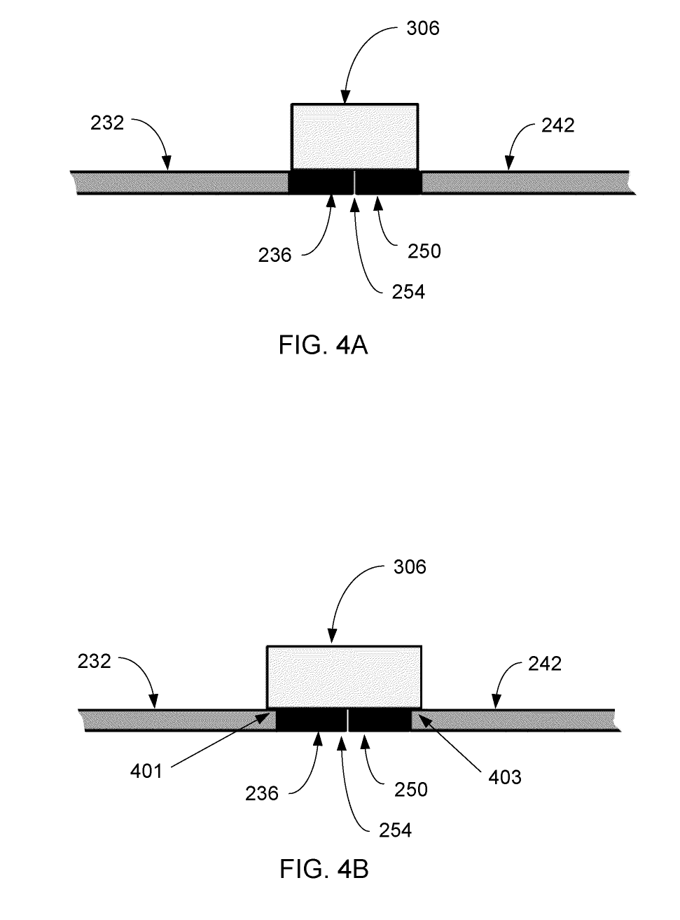

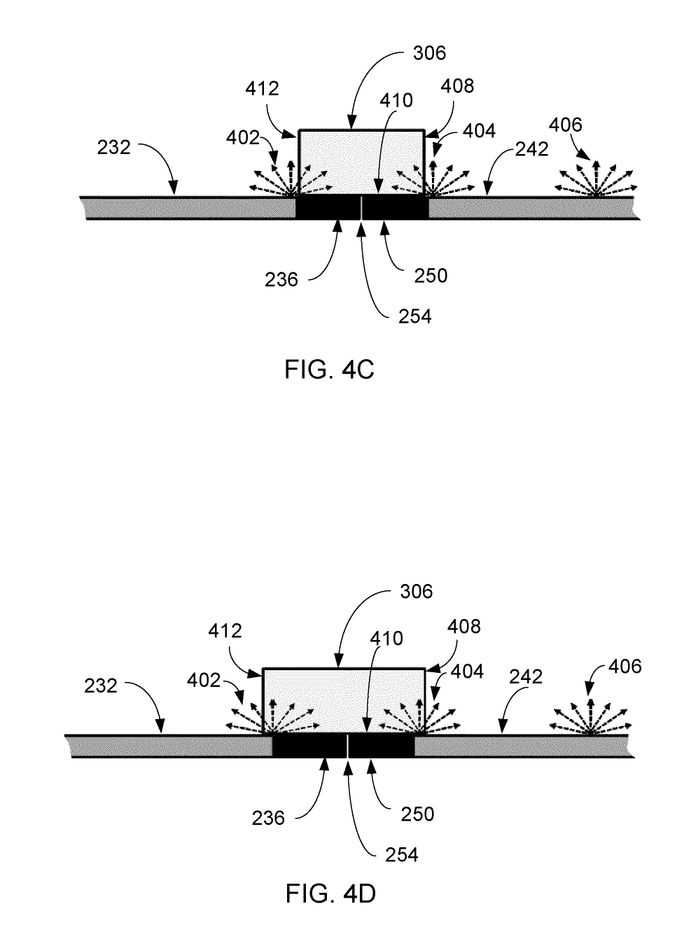

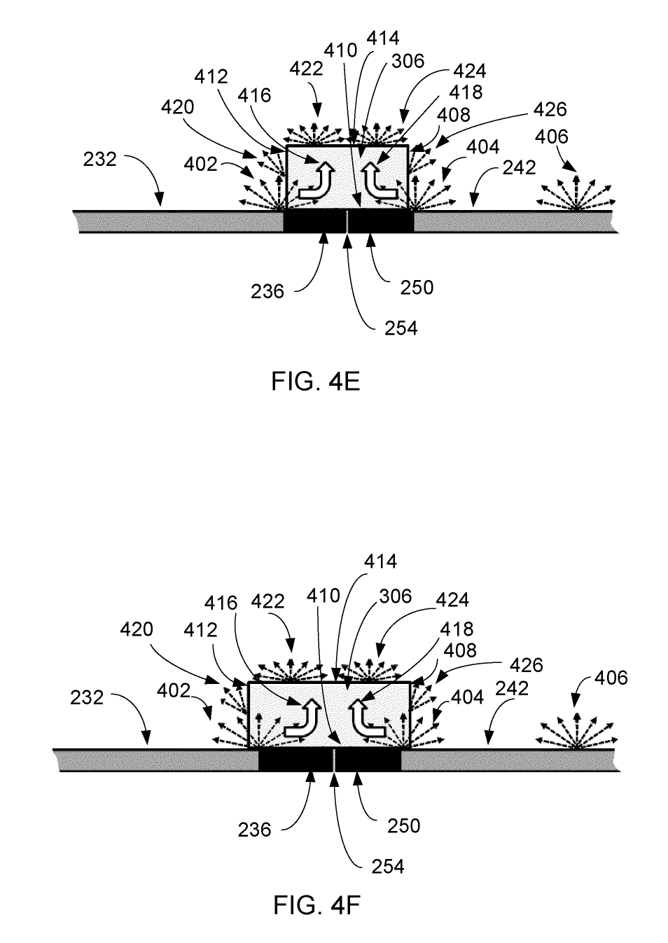

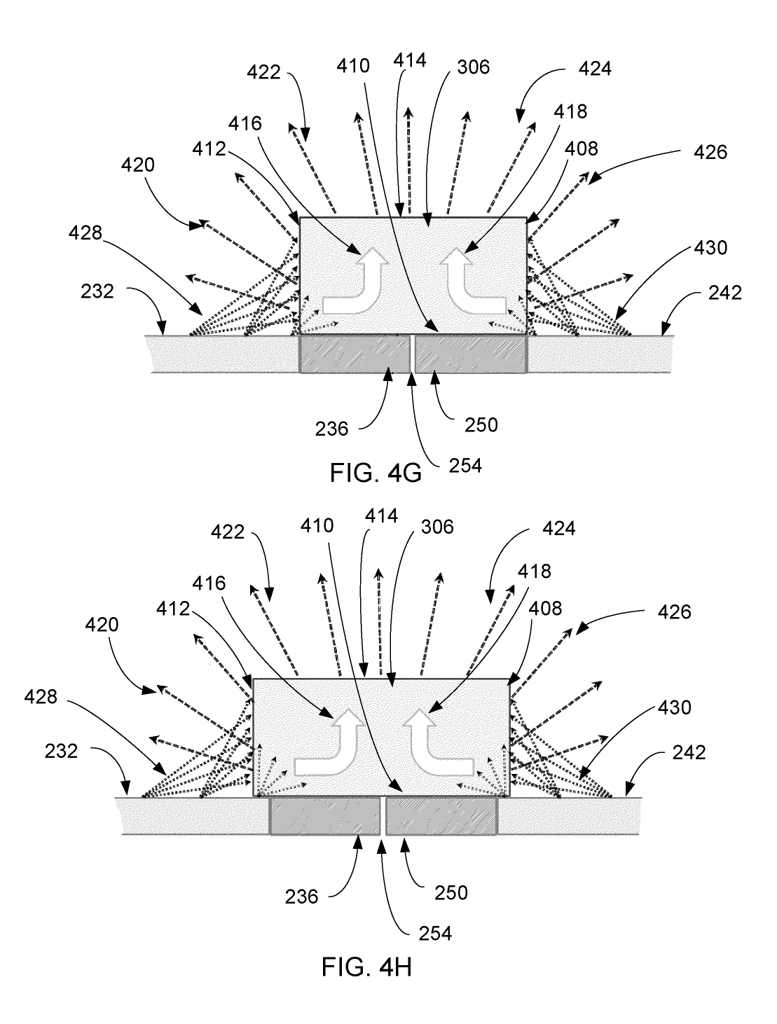

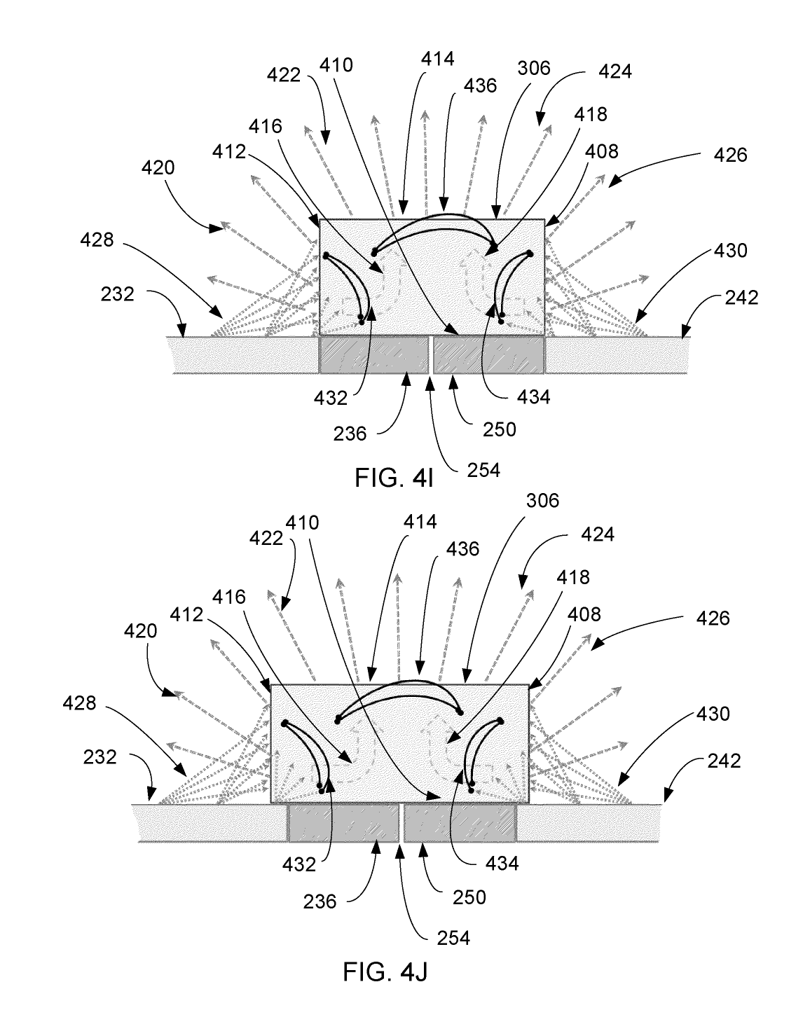

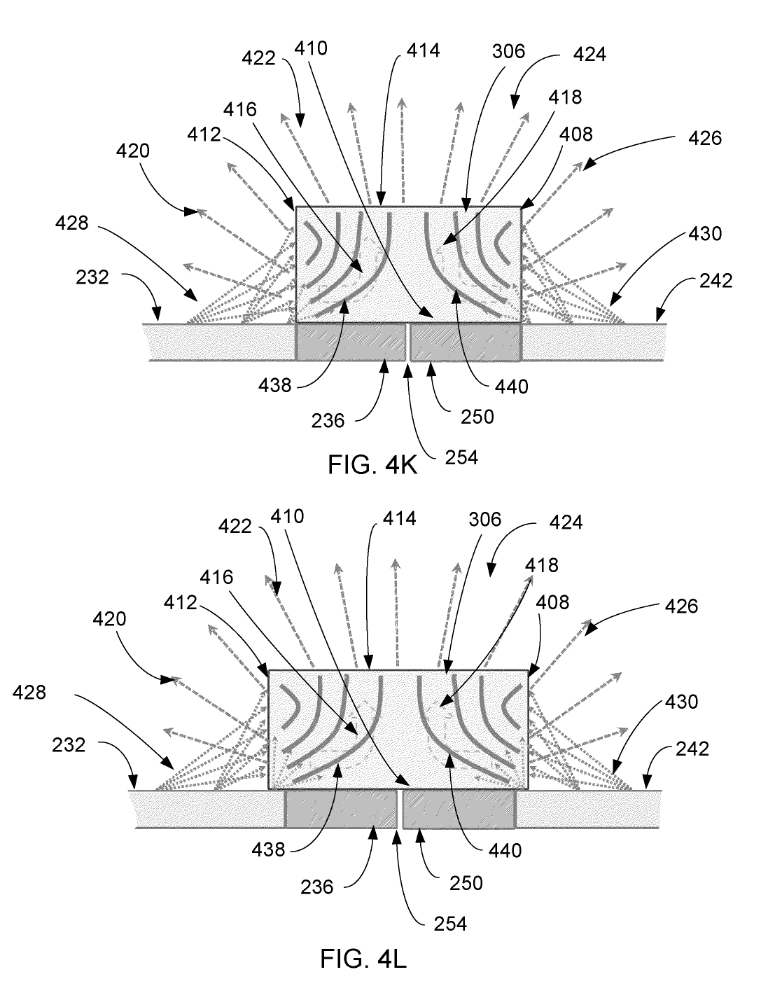

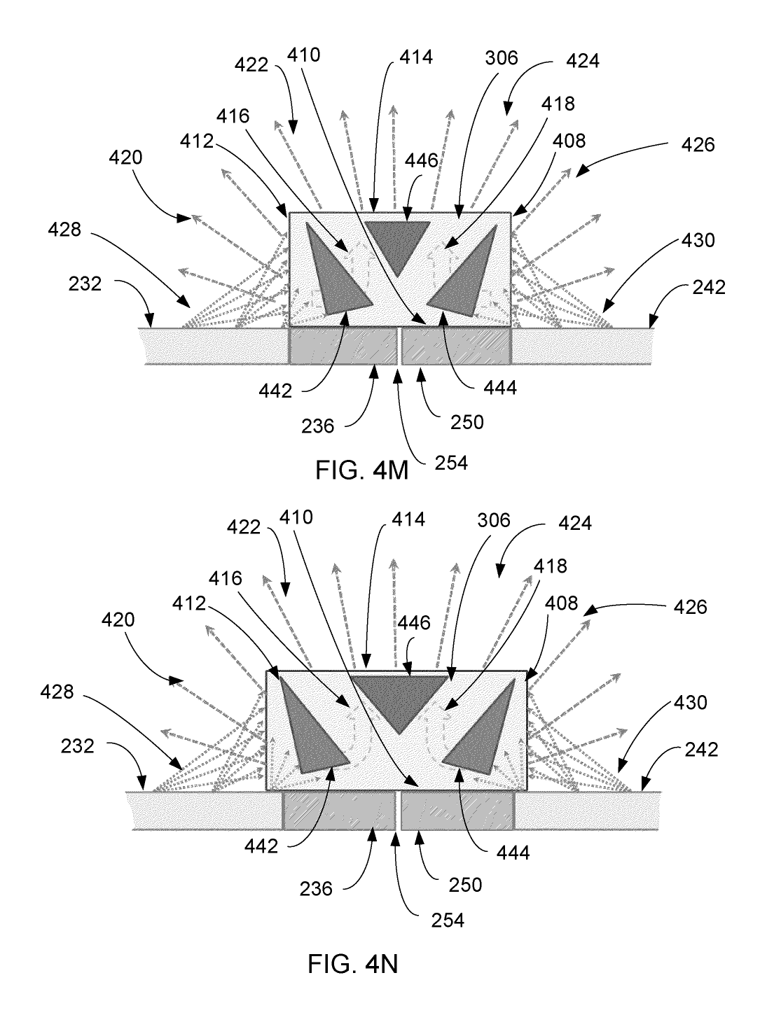

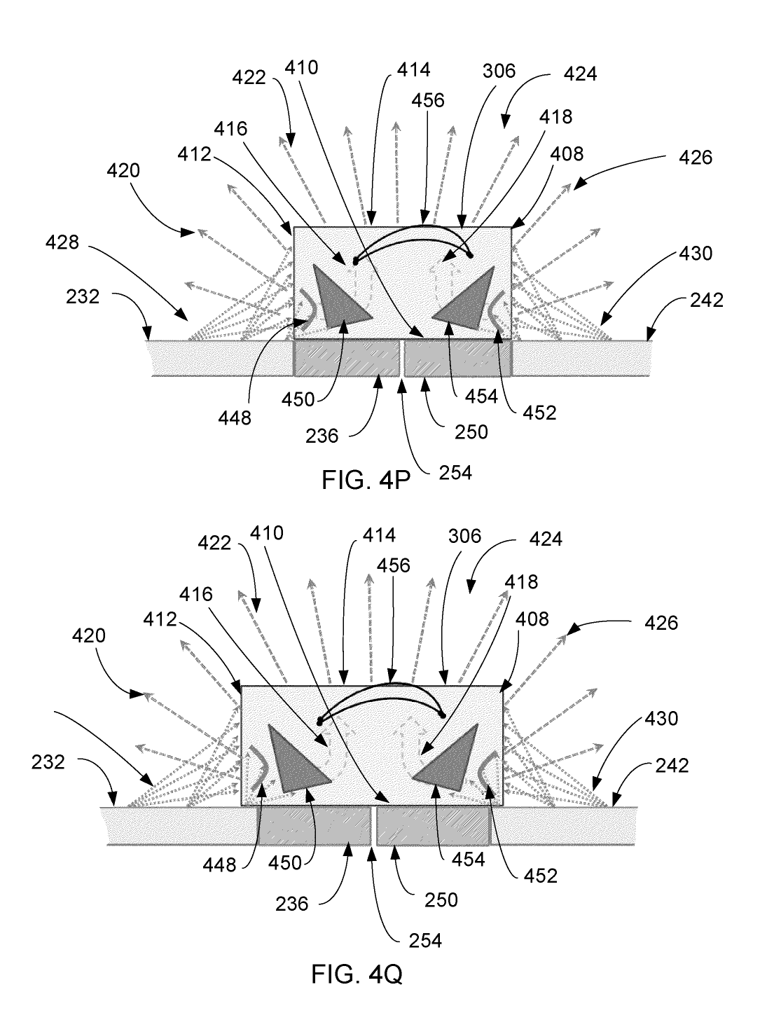

FIG. 4A illustrates a cross sectional view of FIG. 3 for an exemplary optical device for providing seamless integration of tiled GUIs, in accordance with an embodiment of the present invention.

Optical device 306 may be configured to be located on top of bezel portion 236 and bezel portion 250 and located over space 254. Optical device 306 may be configured as to not cover portions of display portion 232 and/or display portion 242. Optical device 306 appears geometrically as rectangular for this representation, however, optical device 306 may be configured in any known geometrical shape. Furthermore, the geometrical shape of optical device 306 may be dependant upon the functional elements contained within optical device 306.

FIG. 4B illustrates a cross sectional view of FIG. 3 for an exemplary optical device for providing seamless integration of tiled GUIs where exemplary optical device may extend over active area of a GUI, in accordance with an embodiment of the present invention.

Optical device 306 may be configured to cover portions of display portion 232 as illustrated by an overlap area 401 and/or display portion 242 as illustrated by an overlap area 403.

FIG. 4C illustrates transmission of optical radiation via GUIs and reception of optical radiation by optical device as depicted in FIG. 4A, in accordance with an embodiment of the present invention.

Optical radiation for display portion 232 may be represented as an optical radiation 402. Optical radiation for display portion 242 may be represented as an optical radiation 404 and an optical radiation 406. Optical radiation 402 may be transmitted in any radial direction with respect display portion 232. Optical radiation 404 and optical radiation 406 may be transmitted in any radial direction with respect to display portion 242. Optical device 306 may receive a larger portion of optical radiation from portions of display portion 242 which may be closer in proximity to the location of optical device 306. For example, optical device may operate to receive a large quantity of optical radiation from optical radiation 404, located in closer proximity to optical device 306, than from optical radiation 406, located a further distance away. Furthermore, for this configuration of optical device 306, a side 408 of optical device 306 may operate to receive optical radiation as generated by display portion 242. Furthermore, for this configuration of optical device 306, a bottom 410 of optical device 306 may operate to receive little if any optical radiation from either display portion 232 or display portion 242. Furthermore, for this configuration of optical device 306, a side 412 may operate to receive optical radiation as generated by display portion 232.

FIG. 4D illustrates transmission of optical radiation via GUIs and reception of optical radiation by optical device as depicted in FIG. 4B, in accordance with an embodiment of the present invention.

For this configuration of optical device 306, optical device 306 may operate to receive optical radiation via bottom 410 from display portion 232 and display portion 242.

FIG. 4E illustrates reception of optical radiation generated from GUIs, as depicted in FIG. 4C, by optical device and transmission of redirected optical radiation by optical device, in accordance with an embodiment of the present invention.

Optical radiation received via side 412 may be redirected upward inside of optical device via a redirection mechanism 416. Lateral and orthogonal optical radiation may be redirected via optical device 306. Optical radiation received via side 408 may be redirected upward inside of optical device 306 via a redirection mechanism 418. Non-limiting examples of redirection mechanisms include optical lenses, optical fibers, optical prisms, nano-optics, optical coatings, micro lenses, micro prisms, flat lenses and mirrors. As a non-limiting example, optical fibers may be constructed of polymeric materials, or similar, of any know type. Any known material capable of redirecting lateral and/or orthogonal optical radiation emanating from display portion 232 and/or display portion 242 may be used for redirection mechanisms 416 and 418 of optical device 306. Furthermore, optical radiation received by optical device 306 may be transmitted external to optical device 306 as denoted by an optical radiation 420, an optical radiation 422, an optical radiation 424 and an optical radiation 426. Optical radiation 420 may be transmitted via side 412, optical radiation 422 and optical radiation 424 may be transmitted via a top 414 and optical radiation 426 may be transmitted via side 408. Transmitted optical radiation from optical device 306 may be viewed by a user or users.

FIG. 4F illustrates reception of optical radiation generated from GUIs, as depicted in FIG. 4D, by optical device and transmission of redirected optical radiation by optical device, in accordance with an embodiment of the present invention.

For this configuration, optical radiation received via bottom 410 may be redirected upward for external transmission from optical device 306.

FIG. 4G illustrates a magnified view of FIG. 4E with reference to optical radiation received by optical device and to optical radiation transmitted by optical device, in accordance with an embodiment of the present invention.

An optical radiation 428 represents the portion of optical radiation 402 (FIG. 4C-F) received by optical device 306 via side 412. An optical radiation 430 represents the portion of optical radiation 404 (FIG. 4C-F) and optical radiation 406 (FIG. 4C-F) received by optical device 306 via side 408. Transmitted optical radiation 420 and 422 represents the redirection and transmission of received optical radiation 428. Transmitted optical radiation 424 and 426 represents the redirection and transmission of received optical radiation 430.

FIG. 4H illustrates a magnified view of FIG. 4F with emphasis on optical radiation received by optical device and on optical radiation transmitted by optical device, in accordance with an embodiment of the present invention.

For this configuration, optical radiation received via bottom 410 may be redirected upward for external transmission from optical device 306.

FIG. 4I illustrates a view of FIG. 4G with optical device implemented via a multiplicity of optical lenses, in accordance with an embodiment of the present invention.

In this example configuration, an optical lens 432 may operate to receive optical radiation 428 via side 412 and redirect optical radiation in an upward fashion. An optical lens 434 may operate to receive optical radiation 430 via side 408 and redirect optical radiation in an upward fashion. An optical lens 436 may operate to receive redirected optical radiation from optical lenses 432 and 434 for transmission external to optical device 306.

FIG. 4J illustrates a view of FIG. 4H with optical device implemented via a multiplicity of optical lenses, in accordance with an embodiment of the present invention.

For this example configuration, optical radiation received via bottom 410 may be redirected upward via optical lenses for external transmission from optical device 306.

FIG. 4K illustrates a view of FIG. 4G with optical device implemented via a multiplicity of optical fibers, in accordance with an embodiment of the present invention.

In this example configuration, a multiplicity of optical fibers with a sampling denoted as an optical fiber 438 may operate to receive optical radiation 428 via side 412 and redirect optical radiation in an upward fashion for transmission external to optical device 306. Furthermore, a multiplicity of optical fibers with a sampling denoted as an optical fiber 440 may operate to receive optical radiation 430 via side 408 and redirect optical radiation in an upward fashion for transmission external to optical device 306.

FIG. 4L illustrates a view of FIG. 4H with optical device implemented via a multiplicity of optical fibers, in accordance with an embodiment of the present invention.

For this example configuration, optical radiation received via bottom 410 may be redirected upward via optical fibers for external transmission from optical device 306.

FIG. 4M illustrates a view of FIG. 4G with optical device implemented via a multiplicity of optical prisms, in accordance with an embodiment of the present invention.

In this example configuration, an optical prism 442 may operate to receive optical radiation 428 via side 412 and redirect optical radiation in an upward fashion. An optical prism 444 may operate to receive optical radiation 430 via side 408 and redirect optical radiation in an upward fashion. An optical prism 446 may operate to receive redirected optical radiation from optical prisms 442 and 444 for transmission external to optical device 306.

FIG. 4N illustrates a view of FIG. 4H with optical device implemented via a multiplicity of optical prisms, in accordance with an embodiment of the present invention.

For this example configuration, optical radiation received via bottom 410 may be redirected upward via optical prisms for external transmission from optical device 306.

FIG. 4P illustrates a view of FIG. 4G with optical device implemented via a multiplicity of optical lenses, fibers and prisms, in accordance with an embodiment of the present invention.

In this example configuration, an optical fiber 448 and an optical prism 450 may operate to receive optical radiation 428 via side 412 and redirect optical radiation in an upward fashion. An optical fiber 452 and an optical prism 454 may operate to receive optical radiation 430 via side 408 and redirect optical radiation in an upward fashion. An optical lens 456 may operate to receive redirected optical radiation from optical fibers 448 and 452 and from optical prisms 450 and 454 for transmission external to optical device 306.

FIG. 4Q illustrates a view of FIG. 4H with optical device implemented via a multiplicity of optical lenses, fibers and prisms, in accordance with an embodiment of the present invention.

For this example configuration, optical radiation received via bottom 410 may be redirected upward via optical prisms, fibers and lenses for external transmission from optical device 306.

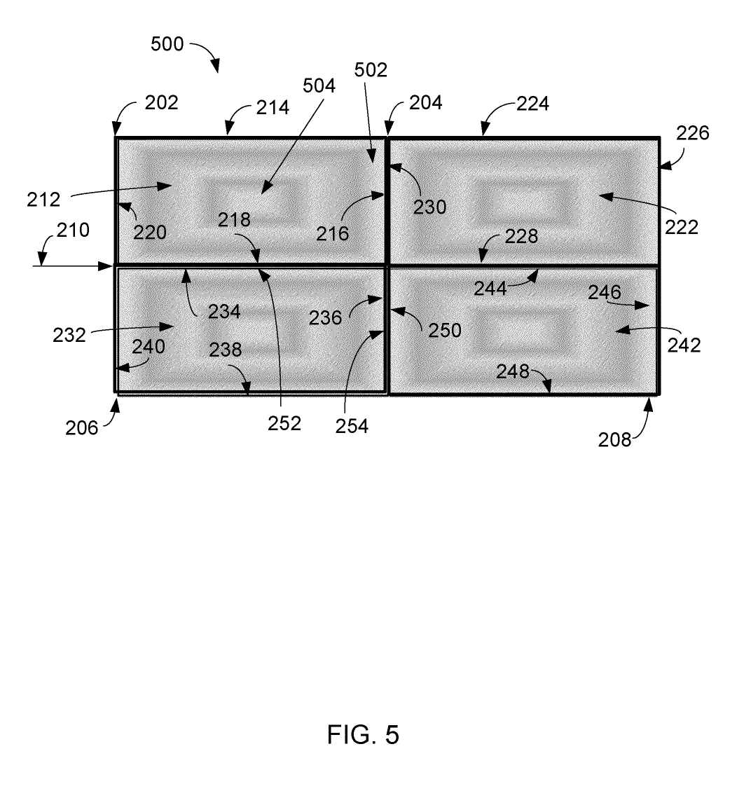

FIG. 5 illustrates non-uniform image intensity, color and/or resolution for generating a uniform image via a tiled GUI, in accordance with an embodiment of the present invention.

Elements of FIG. 2 and FIG. 3 in common with FIG. 5, previously described with reference to FIG. 2 & FIG. 3, will not be described with respect to FIG. 5.

The performance of tiled GUI 300 (FIG. 3) with respect to uniformity may be improved via image processing and other enhancement techniques as illustrated by a compensated tiled GUI 500. Non-limiting examples of characteristics which may be processed or enhanced for improved uniformity include brightness, color, color hue and resolution.

An image displayed in locations overlaid by optical devices 302, 304, 306, 308 and 310 (FIG. 3) may decrease in uniformity as a result of the losses sustained as a result of optical radiation dispersion and other losses attributed to the materials used for manufacture of the optical devices. In order to compensate for the decrease in uniformity in areas overlaid by the optical devices, the image projected by display portions 212, 222, 232 and 242 may be manipulated in the areas of the display adjacent to the optical devices and also in areas not adjacent to the optical devices. For example, the image projected by an adjacent portion 502 of display portion 212 located adjacent to bezel portion 216 may be modified in order to compensate for the losses attributed to the overlaid optical devices and produce a uniform display of information. Furthermore, the image projected by a center portion 504 may be modified in order to compensate for the losses attributed to the overlaid optical devices and produce a uniform display of information.

For example without limitation, modification of the displayed image may be performed external to compensated tiled GUI 500 via the signal received via communication channel 210. Furthermore without limitation, the displayed image may be processed internally to compensated tiled GUI 500 to modify the signal as received via communication channel 210. Furthermore without limitation, the backlighting of LCD monitors may be increased in intensity or decreased in intensity for various areas of the displayed image. Furthermore without limitation, OLED monitors may be programmed to project increased image brightness near the borders of a display. Furthermore without limitation, the resolution of the displayed image may be modified for various areas of the displayed image. For example, the resolution of the image may be decreased near center portion 504 and increased near adjacent portion 502 in order to compensate and generate a uniformly displayed image.

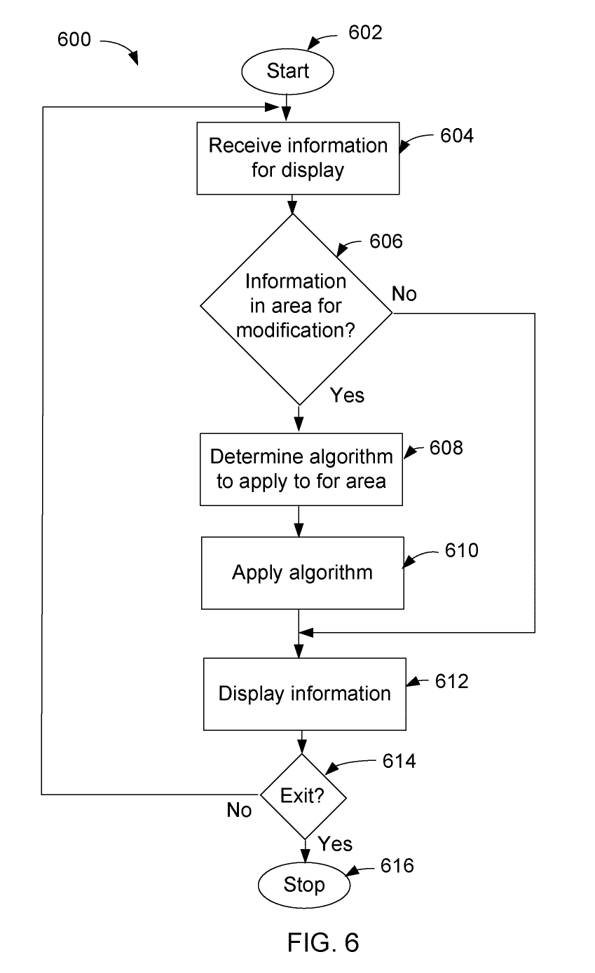

FIG. 6 presents a flow chart illustrating an exemplary method 600 for modification of a display of information via processing as described with reference to FIG. 5 in order to compensate for losses attributed to optical devices 302, 304, 306, 308 and 310 (FIG. 3) for generating a uniform display of information.

For the present embodiment, the process initiates in a step 602. In a step 604, information may be received by compensated tiled GUI 500 via communication channel 210 (FIG. 5). In a step 606, a determination may be performed as to whether received information for display resides in an area for processing and/or modification. For example adjacent portion 502 (FIG. 5) of display portion 212 (FIG. 5) located adjacent to bezel portion 216 (FIG. 5) may be determined as an area appropriate for processing and/or modification. For a determination of information residing in an area for processing and/or modification, in a step 608 the appropriate algorithm for applying to the received information may be determined. In a step 610, the appropriate algorithm determined in step 608 may be applied to the received information. In a step 612, information may be displayed as a result of applying an algorithm in step 610 or as a result of not applying processing or modification as determined in step 606. In a step 614, a determination may be performed as to whether to exit method 600. For a determination of not exiting method 600 in step 614, execution of method 600 transitions to step 604. For a determination of exiting method 600 in step 614, execution of method 600 terminates in a step 616.

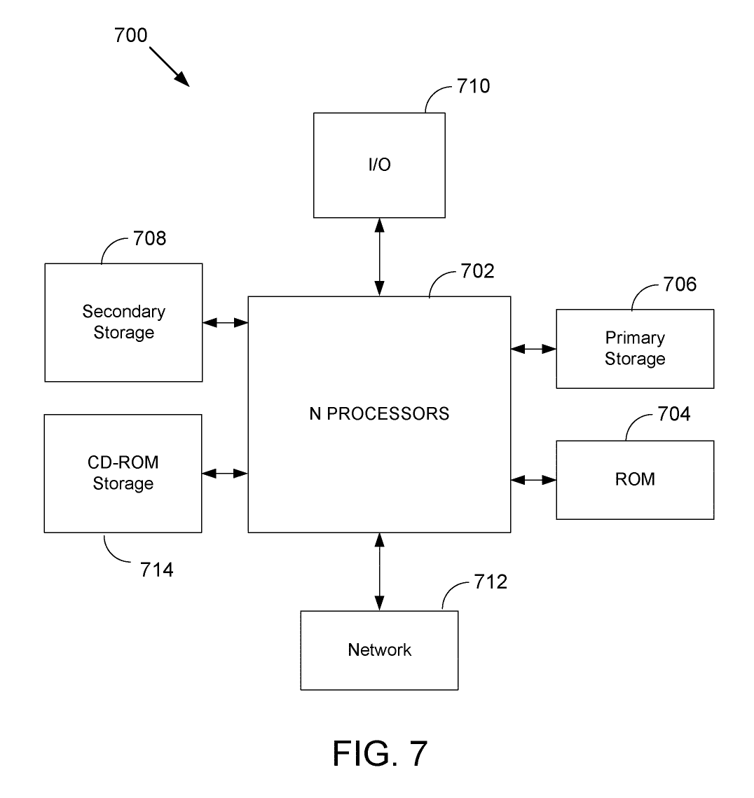

FIG. 7 illustrates a typical computer system that, when appropriately configured or designed, may serve as a computer system 700 for which the present invention may be embodied.

Computer system 700 includes a quantity of processors 702 (also referred to as central processing units, or CPUs) that may be coupled to storage devices including a primary storage 706 (typically a random access memory, or RAM), a primary storage 704 (typically a read only memory, or ROM). CPU 702 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors. As is well known in the art, primary storage 704 acts to transfer data and instructions uni-directionally to the CPU and primary storage 706 typically may be used to transfer data and instructions in a bi-directional manner. The primary storage devices discussed previously may include any suitable computer-readable media such as those described above. A mass storage device 708 may also be coupled bi-directionally to CPU 702 and provides additional data storage capacity and may include any of the computer-readable media described above. Mass storage device 708 may be used to store programs, data and the like and typically may be used as a secondary storage medium such as a hard disk. It will be appreciated that the information retained within mass storage device 708, may, in appropriate cases, be incorporated in standard fashion as part of primary storage 706 as virtual memory. A specific mass storage device such as a CD-ROM 714 may also pass data uni-directionally to the CPU.

CPU 702 may also be coupled to an interface 710 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 702 optionally may be coupled to an external device such as a database or a computer or telecommunications or internet network using an external connection shown generally as a network 712, which may be implemented as a hardwired or wireless communications link using suitable conventional technologies. With such a connection, the CPU might receive information from the network, or might output information to the network in the course of performing the method steps described in the teachings of the present invention.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

Having fully described at least one embodiment of the present invention, other equivalent or alternative methods of providing seamless tiled GUIs according to the present invention will be apparent to those skilled in the art. The invention has been described above by way of illustration, and the specific embodiments disclosed are not intended to limit the invention to the particular forms disclosed. For example, the particular implementation of the seamless tiled GUI may vary depending upon the particular type display device used. The devices and apparatuses described in the foregoing were directed to LCD device implementations; however, similar techniques may be provided for other types of display devices. Implementations of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. An apparatus comprising:
means for overlaying at least a portion of a non-displaying area between adjacent display panels of a tiled group of display panels; and
means substantially disposed within said overlaying means for directing light emitted by the adjacent display panels to obscure the portion of the non-displaying area with the directed light.

2. The apparatus as recited in claim 1, further comprising means for processing information to be displayed on the display panels to produce a substantially uniform and seamless display of information on the tiled group of display panels.

3. An apparatus comprising:
an optical device having dimensions suitable for overlaying at least a portion of a non-displaying area between adjacent display panels of a tiled group of display panels, said optical device further having a bottom for contacting the adjacent display panels, sides and a top; and
a plurality of optical elements substantially disposed within said optical device where said plurality of optical elements are operable for directing light, emitted by the adjacent display panels, to said top to obscure the portion of the non-displaying area with the directed light.

4. The apparatus as recited in claim 3, in which said plurality of optical elements receives light from said sides.

5. The apparatus as recited in claim 4, in which said bottom overlaps displaying areas of the adjacent display panels.

6. The apparatus as recited in claim 5, in which said plurality of optical elements receives a portion of light from said bottom.

7. The apparatus as recited in claim 3, in which the non-displaying area includes bezels of the adjacent panels.

8. The apparatus as recited in claim 7, in which said bottom contacts bezels of the adjacent panels.

9. The apparatus as recited in claim 3, in which said dimensions of said optical device are suitable for overlaying all non-displaying areas between adjacent display panels.

10. The apparatus as recited in claim 10, in which said optical device intersects its self.

11. The apparatus as recited in claim 3, in which said plurality of optical elements comprises elements chosen from a group comprising optical lenses, optical fibers, optical prisms, nano-optics, optical coatings, micro lenses, micro prisms, flat lenses and mirrors.

12. The apparatus as recited in claim 3, in which said optical device comprises a generally rectangular shape.

13. The apparatus as recited in claim 9, further comprising means for processing information to be displayed on the display panels to produce a substantially uniform and seamless display of information on the tiled group of display panels.

14. The apparatus as recited in claim 13, in which brightness of display areas of the display panels are manipulated.

15. The apparatus as recited in claim 13, in which resolutions of display areas of the display panels are modified.

16. A method for processing information to be displayed on display panels to produce a substantially uniform and seamless display of information on a tiled group of display panels utilizing an apparatus for obscuring a non-displaying area between adjacent display panels, the method comprising steps of:
receiving a portion of the information intended for display on the tiled group of display panels;
determining if said portion is to be displayed in a predetermined area that has been designated for a modification;
if said portion is in said predetermined area, determining an algorithm to produce said modification and applying said algorithm to said portion; and
displaying said portion.

17. The method as recited in claim 16, in which said predetermined area is adjacent to a bezel of the tiled group of display panels.

18. The method as recited in claim 17, in which said modification is to compensate for the apparatus.

19. The method as recited in claim 16, in which said modification varies display intensity.

20. The method as recited in claim 16, in which said modification varies display resolution.
